(19) United States
(12) Patent Application Publication
(10) Pub. No.: US 2026/0224416 A1
(43) Pub. Date: Aug. 6, 2026

(54) ELECTRIC WHEELCHAIR

(71) Applicant: JTEKT CORPORATION, Kariya-shi (JP)

(72) Inventors: Nobuyuki TOGASHI, Nara (JP); Hiroshi KITAMOTO, Aichi (JP); Nobuaki IKEHARA, Nara (JP); Riku NAGAYAMA, Nara (JP); Chishin YOHENA, Nara (JP)

(73) Assignee: JTEKT CORPORATION, Kariya-shi (JP)

(21) Appl. No.: 19/149,713

(22) PCT Filed: Feb. 6, 2023
(86) PCT No.: PCT/JP2023/003827

§ 371 Date: Jul. 21, 2025

(51) Int. Cl. A61G 5/04; A61G 5/06; A61G 5/10

(52) U.S. Cl. CPC A61G 5/045; A61G 5/061; A61G 5/101; A61G 2203/10; A61G 2203/34

(57) ABSTRACT

An electric wheelchair includes a vehicle body, a drive wheel that causes the vehicle body to travel, a motor that drives the drive wheel, a grip to be held by an operator and displaceable in a front-rear direction of the vehicle body, an operation detection unit that detects a position of the grip in the front-rear direction, a brake detection unit that detects a brake operation on the vehicle body by the operator, and a control device that controls the motor based on the position detected by the operation detection unit. When the grip is switched from a holding state to a non-holding state by the operator or when the brake detection unit is switched from a brake operation termination state to a brake operation state, the control device controls a braking force applied to the motor to be greater than the braking force before switching.

### DESCRIPTION

### Technical Field

The present disclosure relates to an electric wheelchair.

### Background Art

Patent Document 1 below describes an electric wheelchair configured to apply a thrust in response to an operation of an operator. In this electric wheelchair, grips to be held by an operator are provided so as to be displaceable in a front-rear direction, and a thrust is applied in response to displacement of the grips. Further, a braking force is applied according to an operation force.

### RELATED ART DOCUMENTS

### Patent Documents

Patent Document 1: Japanese Unexamined Patent Application Publication No. 10-336803 (JP 10-336803 A)

### SUMMARY OF THE INVENTION

### Problem to be Solved by the Invention

In the electric wheelchair, the operator can operate the electric wheelchair while the operator is holding the grips, but the operator cannot operate the electric wheelchair while the operator is not holding the grips. Therefore, there is a need to improve the safety of the electric wheelchair while the operator is not holding the grips.

When the operator performs a brake operation on a brake lever to stop the electric wheelchair, a high braking force needs to be exerted in response to the brake operation of the operator from the viewpoint of safety.

The present invention has been made in view of such issues, and provides an electric wheelchair that is excellent in safety.

One aspect of the present disclosure is an electric wheelchair including: a vehicle body; a drive wheel that causes the vehicle body to travel; a motor that drives the drive wheel; a grip to be held by an operator and displaceable in a front-rear direction of the vehicle body by an operation of the operator; an operation detection unit that detects a position of the grip in the front-rear direction; a brake detection unit that detects a brake operation on the vehicle body by the operator; and a control device that controls the motor based on the position detected by the operation detection unit. The control device performs control to apply a braking force to the motor according to a rotation speed of the drive wheel when the grip is in an operating state made by the operator, when the grip is in a holding state made by the operator, or when the brake detection unit is in a brake operation termination state. When the grip is switched from the operating state to a non-operating state by the operator, when the grip is switched from the holding state to a non-holding state by the operator, or when the brake detection unit is switched from the brake operation termination state to a brake operation state, the control device controls the braking force applied to the motor to be greater than the braking force before switching.

### Effects of the Invention

In the above aspect, the control device performs control to apply the braking force to the motor according to the rotation speed of the drive wheel when the state of the grip is the operating state made by the operator, when the state of the grip is the holding state made by the operator, or when the brake detection unit is in the brake operation termination state.

When the state of the grip is switched from the operating state to the non-operating state, when the state of the grip is switched from the holding state to the non-holding state, or when the brake detection unit is switched from the brake operation termination state to the brake operation state, the control device controls the braking force applied to the motor to be greater than that before the switching. That is, when the state is switched, the braking force applied to the motor is greater than that before the state is switched.

Therefore, when the grip is switched from the operating state to the non-operating state, when the grip is switched from the holding state to the non-holding state, or when the brake detection unit is switched from the brake operation termination state to the brake operation state, the braking force is greater than that before the switching, thereby improving safety.

As described above, according to the above aspect, it is possible to provide the electric wheelchair that is excellent in safety.

Signs in parentheses in the claims indicate corresponding relationships with specific means described in the embodiments described below, and are not intended to limit the technical scope of the present disclosure.

### BRIEF DESCRIPTION OF THE DRAWINGS

The foregoing and other objects, features, and advantages of the present disclosure will become more apparent from the following detailed description when taken in conjunction with the accompanying drawings.

FIG. 1 is a perspective view of an electric wheelchair according to an embodiment.

FIG. 2 is a diagram of a drive unit disposed on a right side of a vehicle body as viewed from the center of the vehicle body in a right-left direction.

FIG. 3 is a sectional view of a first operation unit.

FIG. 4 is a block diagram showing an example of a configuration for controlling the operation of a motor in the electric wheelchair.

FIG. 5 is a diagram for describing a control logic of a control device for a drive mechanism.

FIG. 6 is a diagram schematically showing a state in which an operator operates the electric wheelchair.

FIG. 7 is a flowchart showing a process to be executed by the control device.

FIG. 8 is a diagram for describing a non-holding determination region of a grip.

FIG. 9 is a flowchart showing a non-holding determination process in FIG. 7.

FIG. 10 is a diagram showing a reference setting pattern of a viscosity coefficient.

FIG. 11 is a diagram showing a first change pattern of the viscosity coefficient.

FIG. 12 is a diagram showing a second change pattern of the viscosity coefficient.

### MODES FOR CARRYING OUT THE INVENTION

Hereinafter, an electric wheelchair that is one embodiment of the above aspect will be described with reference to the drawings.

### Embodiment

### 1. Overall Structure of Electric Wheelchair 1

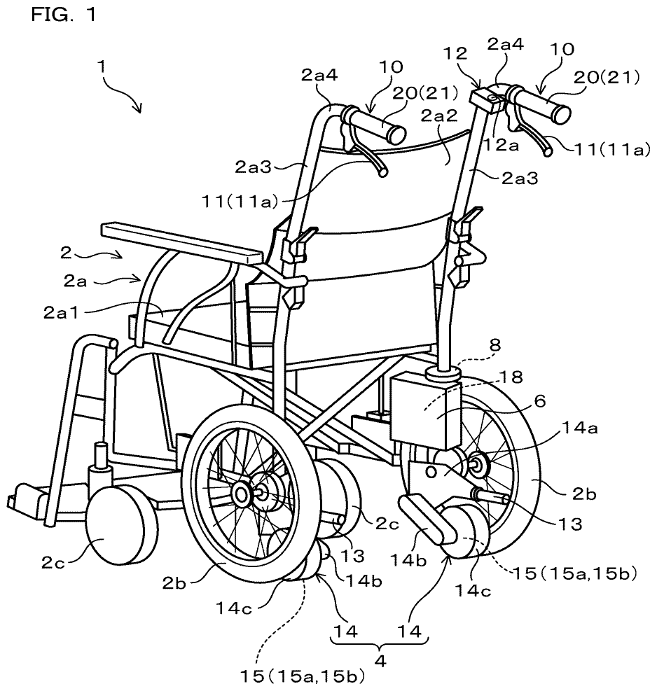

As shown in FIG. 1, an electric wheelchair I according to the embodiment is an electric vehicle that travels by an operation of an operator. The traveling of the electric wheelchair 1 is assisted by drive wheels 14c that are electrically driven.

The electric wheelchair 1 includes a wheelchair unit 2, a drive mechanism 4, a control box 6, a first operation unit 10, and a second operation unit 12. The wheelchair unit 2 is a general wheelchair, and includes a vehicle body 2a mainly made of a frame using metal pipes etc., a pair of main wheels 2b, and a pair of casters 2c. The pair of casters 2c is provided on both right and left sides of the vehicle body 2a. The pair of main wheels 2b is also provided on both the right and left sides of the vehicle body 2a. The pair of main wheels 2b is provided behind the pair of casters 2c. Therefore, the pair of main wheels 2b is rear wheels. The pair of casters 2c is front wheels.

The vehicle body 2a includes a seat portion 2a1 on which an occupant sits, and a backrest portion 2a2. The vehicle body 2a includes a pair of right and left support pipes 2a3. The pair of support pipes 2a3 supports the backrest portion 2a2. A pair of protrusions 2a4 is provided at the upper ends of the pair of support pipes 2a3. The pair of protrusions 2a4 protrudes rearward from the backrest portion 2a2. The pair of protrusions 2a4 is pipes having openings at the rear ends. A pair of first operation units 10 is provided on the pair of protrusions 2a4. Therefore, the pair of first operation units 10 is disposed above the right and left sides of the backrest portion 2a2. The pair of first operation units 10 includes grips 20. The second operation unit 12 is provided on the right protrusion 2a4. The second operation unit 12 includes a plurality of operation switches 12a for receiving operations of the operator. The plurality of operation switches 12a includes an operation switch for turning the power supply on and off, and an operation switch for switching the state of the drive mechanism 4 between a state in which assistance for the movement of the electric wheelchair l is started and a state in which the assistance is terminated.

The first operation unit 10 includes a brake lever 11 and a brake sensor 11a for detecting a brake operation and a brake release operation of the brake lever 11. The brake lever 11 has a function of mechanically applying a braking force to the drive wheels 14c or the main wheels 2b by the brake operation of the operator. The brake sensor 11a is a brake detection unit that detects the brake operation of the operator to apply a braking force to the vehicle body 2a. The brake operation on the brake lever 11 by the operator is detected by the brake sensor 11a in a brake operation state. The brake release operation on the brake lever 11 by the operator is detected by the brake sensor 11a in a brake operation termination state. In the present embodiment, the magnitude of the braking force to be applied to motors 15 is controlled to change based on the operation state of the brake lever 11.

In the following description, a direction in which the occupant faces the front when the occupant rides on the electric wheelchair 1 (direction in which the backrest portion 2a2 faces the front) is defined as a forward direction, and the opposite direction is defined as a rearward direction. Therefore, the occupant rides on the electric wheelchair 1 while facing forward. A direction in which the occupant faces the left side is defined as a leftward direction, and a direction in which the occupant faces the right side is defined as a rightward direction.

The drive mechanism 4 includes a pair of drive units 14. The pair of drive units 14 is fixed to the right and left sides of the vehicle body 2a. The pair of drive units 14 is disposed on the vehicle inner side of the pair of main wheels 2b. Each of the pair of right and left drive units 14 includes a base plate 14a, an arm 14b, the drive wheel 14c, the motor 15, and a tipping bar 13.

### 2. Structure of Drive Unit 14

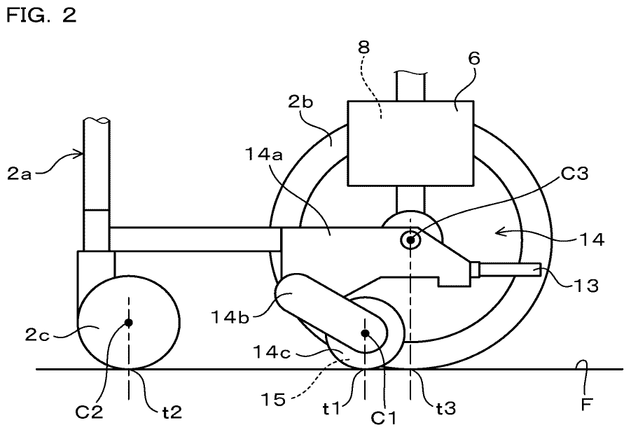

As shown in FIGS. 1 and 2, the base plate 14a is fixed to the frame of the vehicle body 2a. Therefore, the drive unit 14 is attached to the wheelchair unit 2. The tipping bar 13 is provided at the rear end of the base plate 14a. The tipping bar 13 is a member that is stepped on by the leg of the operator who is operating the electric wheelchair 1 from the rear when the operator is climbing over a step. When the operator steps on the tipping bar 13, the casters 2c are lifted upward with the main wheels 2b as pivot points.

The arm 14b is provided on the vehicle inner side of the base plate 14a. The arm 14b is fixed to the base plate 14a so as to be swingable up and down. The arm 14b is swingable within a predetermined angle range. The motor 15 and the drive wheel 14c are provided at the tip of the arm 14b. The arm 14b rotatably supports the drive wheel 14c. The arm 14b elastically urges the drive wheel 14c downward. Therefore, the arm 14b presses the drive wheel 14c against a road surface to bring it into contact with the road surface.

The motor 15 is an in-wheel motor and is provided inside the drive wheel 14c. A rotor (not shown) of the motor 15 can rotate together with the drive wheel 14c. A stator (not shown) of the motor 15 is fixed to the arm 14b side. Thus, the motor 15 drives the drive wheel 14c to rotate. The motor 15 is connected to a battery, a control device, etc. in the control box 6 via a cable (not shown). The cable is inserted through the arm 14b and connects the motor 15 and the control box 6. The control box 6 is fixed to a frame portion on the lower right side of the seat portion 2a1. The control box 6 houses the battery, the control device for controlling each part, etc.

The drive wheel 14c is supported by the arm 14b so as to be rotatable about a rotation axis C1 (see FIG. 2) that is parallel to the right-left direction. The drive wheel 14c is driven to rotate by the motor 15 while being in contact with the road surface. The pair of right and left motors 15 drives the pair of right and left drive wheels 14c, thereby causing the wheelchair unit 2 (vehicle body 2a) to travel.

As shown in FIG. 2, the drive wheel 14c is disposed between the caster 2c and the main wheel 2b. More specifically, the position of the rotation axis C1 in the front-rear direction is between a rotation axis C2 of the caster 2c and a rotation axis C3 of the main wheel 2b. Therefore, a ground contact position t1 of the drive wheel 14c on a road surface F is located between a ground contact position t2 of the caster 2c and a ground contact position t3 of the main wheel 2b. The ground contact position t1 of the drive wheel 14c may be located in the range from the ground contact position t2 to the ground contact position t3. In other words, the position of the rotation axis C1 in the front-rear direction may be located in the range from the position of the rotation axis C2 to the position of the rotation axis C3.

### 3. Structure of First Operation Unit 10

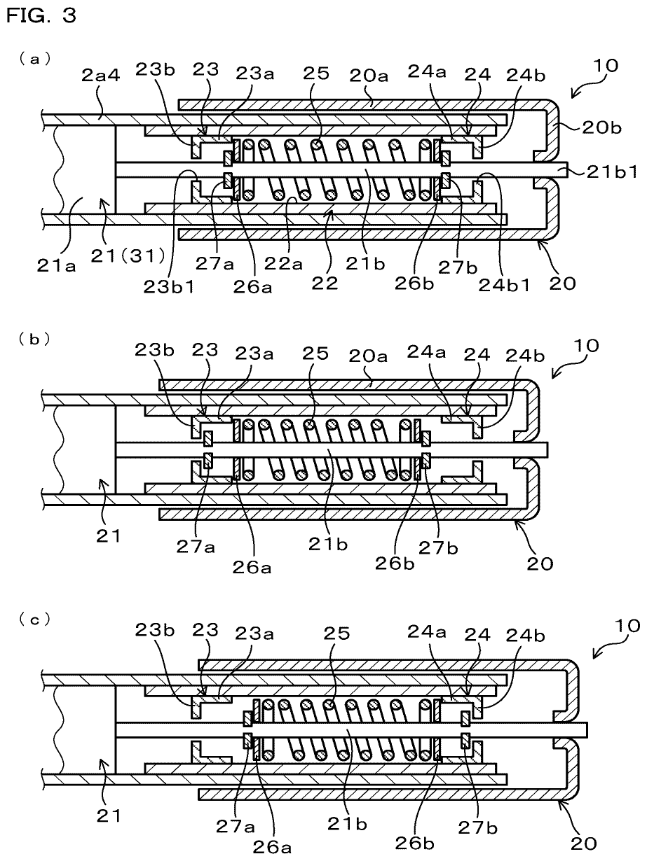

As shown in part (a) in FIG. 3, the first operation unit 10 includes an operation detection unit 21 in addition to the grip 20. The grip 20 is attached to the tip of the protrusion 2a4 on the vehicle left side. The grip 20 includes a tubular portion 20a and a bottom portion 20b. The bottom portion 20b closes the opening on the rear side of the tubular portion 20a. The tubular portion 20a is attached to the outer circumferential side of the protrusion 2a4. The tubular portion 20a is movable while sliding on the outer circumferential surface of the protrusion 2a4. Therefore, the grip 20 is movable along an axial direction of the protrusion 2a4. The protrusion 2a4 extends along the front-rear direction. Therefore, the grip 20 can be held by the operator and can be displaced in the front-rear direction relative to the vehicle body 2aby the operation of the operator.

The operation detection unit 21 has a function of detecting the position and the displacement amount of the grip 20 in the front-rear direction as displacement information of the grip 20 in the front-rear direction. The operation detection unit 21 also has a function of detecting information about the grip 20 being held by the operator from the displacement information of the grip 20 in the front-rear direction. Therefore, the operation detection unit 21 is a state sensor that detects the operating state or the holding state of the operator for the grip 20.

In the present embodiment, the operation detection unit 21 is a potentiometer. The operation detection unit 21 is provided inside the protrusion 2a4. The operation detection unit 21 includes a body 21a and a rod 21b. The body 21a is fixed to the protrusion 2a4. The rod 21b extends rearward from the body 21a. The rod 21b passes through the tubular portion 20a and the protrusion 2a4. The rod 21b is movable in the axial direction relative to the body 21a. The operation detection unit 21 detects and outputs the displacement amount of the rod 21b in the axial direction. A tip 21b1 of the rod 21b is fixed to the bottom portion 20b. Therefore, the rod 21b moves together with the grip 20 in the front-rear direction. Thus, the operation detection unit 21 can detect the displacement amount of the grip 20 in the front-rear direction relative to the vehicle body 2a. The operation detection unit 21 is connected to the control device described later inside the control box 6. The output of the operation detection unit 21 is provided to the control device.

In addition to the above operation detection unit 21, a sleeve 22, a front bush 23, a rear bush 24, and a spring 25 are provided inside the protrusion 2a4. The sleeve 22 is a cylindrical member that is inserted into and fixed to the inner circumferential surface of the protrusion 2a4. The front bush 23, the rear bush 24, and the spring 25 are disposed on the inner circumferential side of the sleeve 22.

The front bush 23 includes a cylindrical portion 23a and a bottom portion 23b. The cylindrical portion 23a is inserted into and fixed to an inner circumferential surface 22a of the sleeve 22. The bottom portion 23b is provided at the front opening of the cylindrical portion 23a. The bottom portion 23b has a central hole 23b1. The rod 21b is inserted through the central hole 23b1. The rear bush 24 includes a cylindrical portion 24a and a bottom portion 24b. The cylindrical portion 24a is inserted into and fixed to the inner circumferential surface 22a of the sleeve 22. The bottom portion 24b is provided at the rear opening of the cylindrical portion 24a. The bottom portion 24b has a central hole 24b1. The rod 21b is inserted through the central hole 24b1.

The spring 25 is disposed between the front bush 23 and the rear bush 24. Therefore, the rod 21b passes through the front bush 23, the rear bush 24, and the spring 25. The rod 21b has a front retainer 26a, a front snap ring 27a, a rear retainer 26b, and a rear snap ring 27b. The front snap ring 27a is provided forward of the spring 25. The front snap ring 27a is fixed to the rod 21b. The front snap ring 27a is fitted to a circumferential groove provided in the rod 21b. Therefore, the front snap ring 27a can move together with the rod 21b in the axial direction. The rear snap ring 27b is provided rearward of the spring 25. The rear snap ring 27b is also fixed to the rod 21b. The rear snap ring 27b is fitted to a circumferential groove provided in the rod 21b. Therefore, the rear snap ring 27b can move together with the rod 21b in the axial direction. That is, the front snap ring 27a and the rear snap ring 27b are fixed to the rod 21b at a constant distance in the axial direction.

The front retainer 26a, the rear retainer 26b, and the spring 25 are disposed between the front snap ring 27a and the rear snap ring 27b. The front retainer 26a and the rear retainer 26b are annular members through which the rod 21b passes. The front retainer 26a and the rear retainer 26b hold the front end face and the rear end face of the spring 25. The front retainer 26a is interposed between the front bush 23 and the front end face of the spring 25. The rear retainer 26b is interposed between the rear bush 24 and the rear end face of the spring 25.

### 4. Neutral Position of Grip 20

Part (a) in FIG. 3 shows the grip 20 in a neutral position. The grip 20 is in the neutral position when it is not being held by the operator or when the operator is not inputting an operation force. When the grip 20 is in the neutral position, the spring 25 urges the front retainer 26a toward the front bush 23. The spring 25 also urges the rear retainer 26b toward the rear bush 24. At this time, the front retainer 26a is in contact with the cylindrical portion 23a of the front bush 23. The rear retainer 26b is in contact with the cylindrical portion 24a of the rear bush 24. That is, when the grip 20 is in the neutral position, the distance between the front retainer 26a and the rear retainer 26b is smaller than the free length of the spring 25.

### 5. Front Position of Grip 20

Part (b) in FIG. 3 shows the grip 20 that has moved to a front position forward of the neutral position. When the grip 20 moves forward from the neutral position, the rod 21b also moves forward. Therefore, the output of the operation detection unit 21 changes. When the grip 20 and the rod 21b move forward from the neutral position, the spring 25 is pressed forward by the rear retainer 26b and the rear snap ring 27b. Thus, the rear retainer 26b moves away from the rear bush 24. When the grip 20 moves further forward, the front snap ring 27a comes into contact with the bottom portion 23b of the front bush 23 as shown in part (b) in FIG. 3. Thus, the front snap ring 27a and the front bush 23 limit the forward movement of the rod 21b.

### 6. Rear Position of Grip 20

Part (c) in FIG. 3 shows the grip 20 that has moved to a rear position rearward of the neutral position. When the grip 20 moves rearward from the neutral position, the rod 21b also moves rearward. Therefore, the output of the operation detection unit 21 changes. When the grip 20 and the rod 21b move rearward from the neutral position, the spring 25 is pressed rearward by the front retainer 26a and the front snap ring 27a. Thus, the front retainer 26a moves away from the front bush 23. When the grip 20 moves further rearward, the rear snap ring 27b comes into contact with the bottom portion 24b of the rear bush 24 as shown in part (c) in FIG. 3. Thus, the rear snap ring 27b and the rear bush 24 limit the rearward movement of the rod 21b.

With the above configuration, the grip 20 is elastically movable in the front-rear direction by the spring 25 with the neutral position at the center. The range of movement of the grip 20 and the rod 21b in the front-rear direction is limited by the front bush 23, the rear bush 24, the front snap ring 27a, and the rear snap ring 27b.

### 7. Configuration of Electric Wheelchair 1

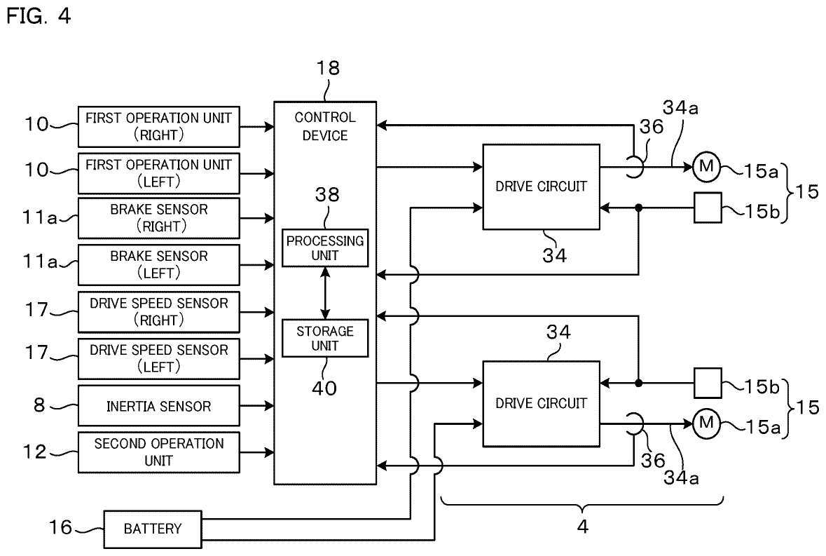

As shown in FIG. 4, the electric wheelchair 1 further includes right and left drive speed sensors 17, an inertia sensor 8, a battery 16, and a control device 18. All of the inertia sensor 8, the battery 16, and the control device 18 are housed in the control box 6 (see FIG. 1).

The drive speed sensor 17 detects the drive speed of the drive wheel 14c. The drive speed sensor 17 is attached to the drive wheel 14c. The drive speed sensor 17 is electrically connected to the control device 18. Therefore, the output of the drive speed sensor 17 is provided to the control device 18. The traveling speed of the vehicle body 2a of the electric wheelchair 1 can be calculated from the drive speed of the drive wheel 14c. Therefore, the drive speed sensor 17 can be regarded as a traveling speed detection unit that detects the traveling speed of the vehicle body 2a of the electric wheelchair 1.

The inertia sensor 8 detects information on inertia acting on the vehicle body 2a. In the present embodiment, the inertia sensor 8 is, for example, an IMU (Inertial Measurement Unit), and includes at least a three-axis acceleration sensor. The inertia sensor 8 is electrically connected to the control device 18. Therefore, the output of the inertia sensor 8 is provided to the control device 18. The control device 18 determines the inclination angle of the vehicle body 2a in the front-rear direction based on the output of the inertia sensor 8. That is, the inertia sensor 8 functions as a sensor for detecting the inclination angle of the vehicle body 2a in the front-rear direction.

The battery 16 supplies electric power to the pair of motors 15 and each part that requires operating power. The control device 18 has a function of controlling the drive mechanism 4 (pair of motors 15) by giving a command value to the drive mechanism 4, thereby controlling the speed of the vehicle body 2a.

The drive mechanism 4 including the pair of motors 15 includes a pair of drive circuits 34. Each of the pair of motors 15 includes a motor body 15a and a rotation detector 15b. The motor body 15a includes main components of a motor, such as a rotor and a stator. The rotation detector 15b is, for example, a Hall sensor provided on the motor body 15a. The rotation detector 15b detects the rotation angle of the rotor of the motor body 15a. The rotation detector 15b is connected to the drive circuit 34 and the control device 18. Therefore, the output of the rotation detector 15b is provided to the drive circuit 34 and the control device 18. At this time, the rotation speed of the motor 15 is derived from the rotation angle of the rotor of the motor body 15a. Therefore, the rotation detector 15b functions as a motor information detection unit that detects motor information on the rotation speed of the motor 15. The motor information detected by the rotation detector 15b is also information on the rotation of the drive wheel 14c. Therefore, the rotation detector 15b can also be regarded as a rotation information detection unit that detects information on the rotation of the drive wheel 14c.

The pair of drive circuits 34 is, for example, inverters. The pair of drive circuits 34 may be housed in the control box 6, or may be provided on the base plates 14a or the arms 14b. The pair of drive circuits 34 is connected to the control device 18, the battery 16, and the pair of motors 15. The pair of drive circuits 34 supplies electric power in the battery 16 to the pair of motors 15. The pair of drive circuits 34 has a function of supplying drive power to the pair of motors 15 based on speed command values provided from the control device 18 and the outputs of the rotation detectors 15b, and controlling the motors 15 such that they reach the rotation speeds indicated by the speed command values.

The pair of drive circuits 34 and the pair of motors 15 (motor bodies 15a) are connected by a pair of power lines 34a. A pair of current detection units 36 is provided on the pair of power lines 34a. The pair of current detection units 36 is current sensors that detect currents flowing through the pair of power lines 34a. That is, the pair of current detection units 36 detects motor currents flowing through the pair of motors 15. The pair of current detection units 36 is connected to the control device 18. Therefore, the outputs of the pair of current detection units 36 are provided to the control device 18.

The pair of first operation units 10 and the second operation unit 12 are also connected to the control device 18. As described above, the outputs of the first operation units 10 (i.e., the outputs of the operation detection units 21) and the output of the second operation unit 12 are provided to the control device 18. In the present embodiment, the outputs of the pair of operation detection units 21 are defined as operation inputs of the pair of grips 20 to the control device 18.

The control device 18 is a computer etc. including a processing unit 38 that is a processor etc. and a storage unit 40 that is a memory, a hard disk, etc. The storage unit 40 stores a computer program to be executed by the processing unit 38 and necessary information. The processing unit 38 implements various processing functions of the control device 18 by executing a computer program stored in a non-transitory computer-readable storage medium such as the storage unit 40.

### 8. Configuration of Control Device 18

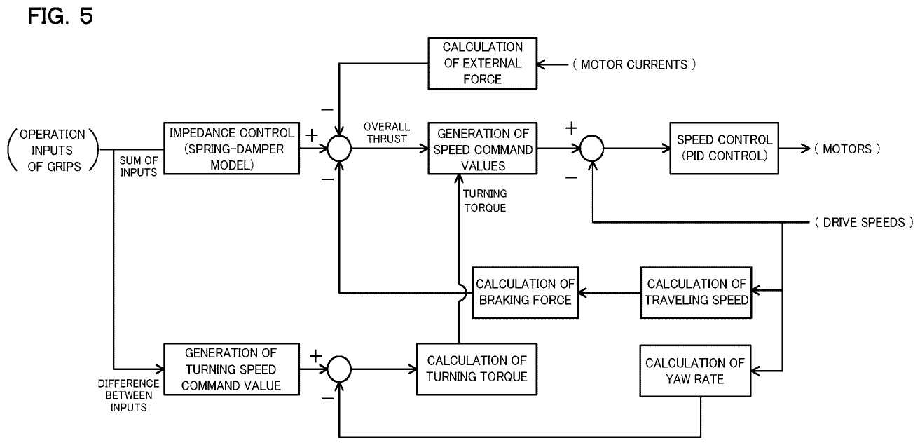

The control device 18 controls the drive mechanism 4 in accordance with a control logic shown in FIG. 5.

Based on the operation inputs of the pair of grips 20, impedance control and generation of a turning speed command value are executed. The impedance control uses a spring-damper model described later. Through the impedance control, a basic thrust is calculated based on the sum of the operation inputs of the pair of grips 20. The turning speed command value is generated based on the difference between the operation inputs of the pair of grips 20. An overall thrust is calculated by subtracting an external force and a braking force from the basic thrust. The external force is calculated based on the motor currents detected by the current detection units 36 (see FIG. 4). The braking force is calculated using the traveling speed. The traveling speed is calculated from the drive speeds detected by the drive speed sensors 17 (see FIG. 4).

Speed command values for the motors 15 are generated based on the overall thrust and a turning speed torque. The turning torque is calculated based on the turning speed command value and a yaw rate. The yaw rate is calculated based on the drive speeds of the drive wheels 14c and a wheel distance between the pair of drive wheels 14c. Then, the speed control on the motors 15 is executed based on the generated speed command values and the drive speeds of the drive wheels 14c. In this speed control, for example, known PID control can be used to improve responsiveness. The PID control is addition of integral operation feedback control (I control) and differential operation feedback control (D control) to control for adjustment in proportion to a deviation between a current output value and a target value (P control).

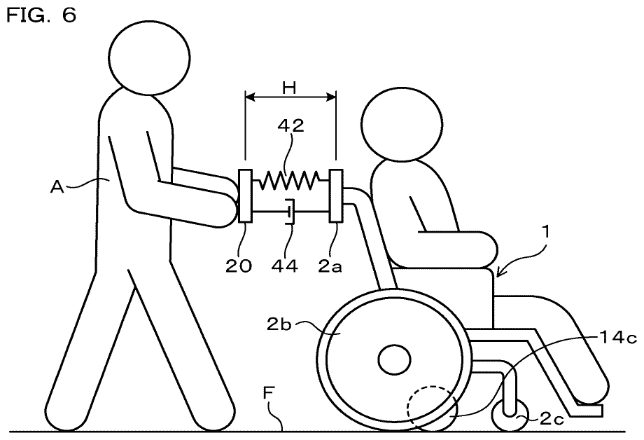

As shown in FIG. 6, when an operator A wants to move the electric wheelchair 1 along the road surface F, the operator A of the electric wheelchair 1 operates the grips 20 of the pair of first operation units 10 while holding them with the right and left hands. At this time, the pair of grips 20 moves in the front-rear direction relative to the vehicle body 2a. The pair of first operation units 10 provides outputs corresponding to the movements of the pair of grips 20 to the control device 18. The control device 18 generates speed command values for the motors 15 based on the outputs provided from the pair of first operation units 10, and provides the speed command values to the pair of drive circuits 34. In this manner, the control device 18 controls the motors 15.

When the operator A holds the grips 20 and operates them to push forward, the motors 15 are controlled such that the drive wheels 14c assist forward movement of the electric wheelchair 1. When the operator A holds the grips 20 and operates them to pull rearward, the motors 15 are controlled such that the drive wheels 14c assist rearward movement of the electric wheelchair 1. When the operator A is in a non-holding state in which he or she is not holding the grips 20 or when the operator A does not operate the grips 20 in the front-rear direction from the neutral positions, the motors 15 are controlled so as not to drive the drive wheels 14c. As described above, the control device 18 determines whether the operator A is in an operating state or a non-operating state relative to the grips 20 or whether the operator A is in the holding state or the non-holding state relative to the grips 20, and controls the motors 15 depending on the operating state or the non-operating state or depending on the holding state or the non-holding state.

The outputs from the pair of first operation units 10 indicate the displacement amounts of the pair of grips 20 in the front-rear direction relative to the vehicle body 2a. The control device 18 determines the displacement amounts of the pair of grips 20 in the front-rear direction based on the outputs of the pair of first operation units 10. The displacement amount is a distance between a reference position (e.g., the neutral position) that is preset within the movable range of the grip 20 and a current position of the grip 20. When the reference position and the current position agree with each other in the front-rear direction, the displacement amount is 0 (zero). The control device 18 discretely acquires the displacement amounts of the grips 20 over time and stores them in the storage unit 40.

When the operator A holds and operates the first operation units 10 and the second operation unit 12, the control device 18 controls the drive mechanism 4 such that the motion of the vehicle body 2a in response to the displacement amounts simulates mechanical impedance characteristics. That is, as shown in FIG. 6, the control device 18 controls the drive mechanism 4 to maintain a constant distance H between the grip 20 and the vehicle body 2a while reproducing a motion in which the grip 20 and the vehicle body 2a are connected by a virtual spring 42 and a virtual damper 44. In the present embodiment, a spring-damper model using the virtual spring 42 and the virtual damper 44 is used for the impedance control (see FIG. 5).

The control on the drive mechanism 4 to maintain the constant distance H between the grip 20 and the vehicle body 2a includes control to maintain the displacement amount at 0 (zero) or at a predetermined set value. Therefore, the control device 18 controls the drive mechanism 4 to move the vehicle body 2a according to the displacement amount of the grip 20. For example, when the operator A moves forward and presses the grip 20 forward, the control device 18 controls the drive mechanism 4 to move the vehicle body 2a forward. Conversely, when the operator A moves rearward and pulls the grip 20 rearward, the control device 18 controls the drive mechanism 4 to move the vehicle body 2a rearward. When the grip 20 is in the reference position (neutral position), the control device 18 controls the drive mechanism 4 to stop the vehicle body 2a.

### 9. Process of Control Device 18

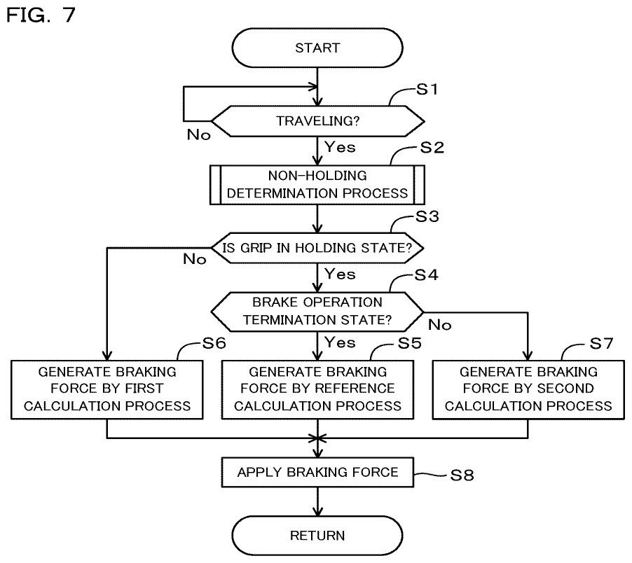

As shown in FIG. 7, the processing unit 38 of the control device 18 executes a process sequentially from step SI to step S8 to control the drive mechanism 4.

The grip 20 in the holding state or the non-holding state is substantially the same as the grip 20 in the operating state or the non-operating state. That is, the operator operates the grip 20 while holding the grip 20, and terminates the holding of the grip 20 when terminating the operation on the grip 20. Therefore, in this specification, “non-holding determination” and “holding determination” will be referred to also as “non-operating determination” and “operating determination,” respectively, and the “non-holding state” and the “holding state” will be referred to also as the “non-operating state” and the “operating state,” respectively.

Step S1 in FIG. 7 is a step of determining whether the electric wheelchair 1 is traveling based on information detected by the drive speed sensors 17 (see FIG. 4). When the electric wheelchair 1 is traveling (“Yes” in step S1), the grips 20 are in the holding state or the operating state for the operator, and the brake levers 11 are in the brake operation termination state for the operator. Then, the process proceeds to step S2.

### 10. Non-Holding Determination Process

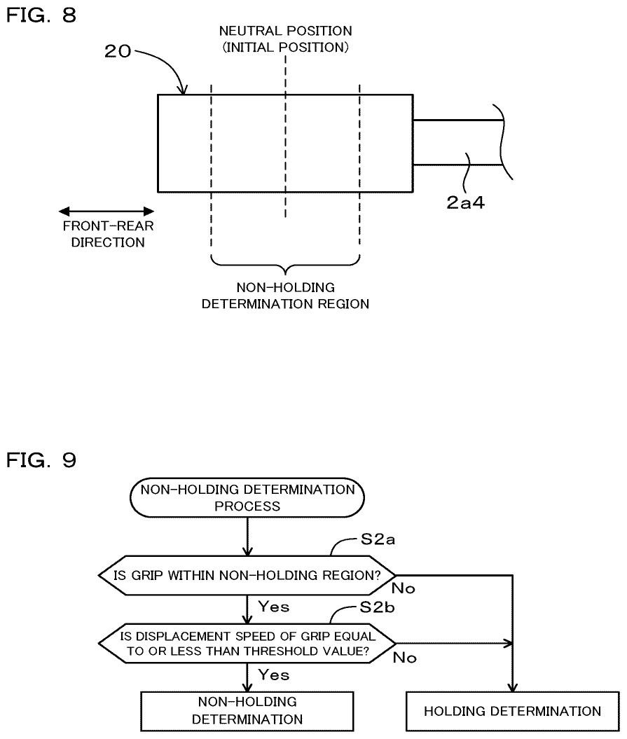

Step S2 is a step of performing a non-holding determination process for the grips 20. The non-holding determination process is a non-operating determination process. In the present embodiment, a non-holding determination region is set for the grip 20 in the non-holding determination process as shown in FIG. 8. The non-holding determination region includes the neutral position (see part (a) in FIG. 3) that is the initial position of the grip 20. The non-holding determination region is a non-operating determination region.

As shown in FIG. 9, the non-holding determination process of step S2 in FIG. 7 includes steps S2a and S2b.

Step S2a is a step of determining whether each grip 20 is within the non-holding determination region. When the grip 20 is within the non-holding determination region (“Yes” in step S2a), the process proceeds to step S2b. When the grip 20 is not within the non-holding determination region (“No” in step S2a), the “holding determination” is made that the grip 20 is in the holding state. This holding determination is also the “operating determination” that the grip 20 is in the operating state.

Step S2b is a step of determining whether the displacement speed of each grip 20 is equal to or less than a threshold value. When the displacement speed of the grip 20 is equal to or less than the threshold value (“Yes” in step S2b), the “non-holding determination” is made that the grip 20 is in the non-holding state. This non-holding determination is also the “non-operating determination” that the grip 20 is in the non-operating state. When the displacement speed of the grip 20 exceeds the threshold value (“No” in step S2b), the “holding determination” is made that the grip 20 is in the holding state. The threshold value used in step S2b is stored in advance in the storage unit 40.

Returning to FIG. 7, step S3 is a step of detecting whether the grip 20 is in the holding state, that is, whether the grip 20 remains in the holding state, based on the result of the non-holding determination process of step S2. When the grip 20 remains in the holding state (“Yes” in step S3), the process proceeds to step S4. When the grip 20 is not in the holding state (“No” in step S3), that is, when the grip 20 is switched from the holding state to the non-holding state, the process proceeds to step S6.

Step S4 is a step of determining whether the brake operation is terminated, that is, whether the brake sensor 11a of the brake lever 11 remains in the brake operation termination state. When the brake sensor 11a remains in the brake operation termination state (“Yes” in step S4), the process proceeds to step S5. When the brake sensor 11a is switched from the brake operation termination state to the brake operation state, the process proceeds to step S7.

### 11. Reference Calculation Process for Braking Force

As shown in FIG. 7, step S5 is a step of generating a braking force by a reference calculation process when the grip 20 remains in the holding state and the brake lever 11 remains in the brake operation termination state.

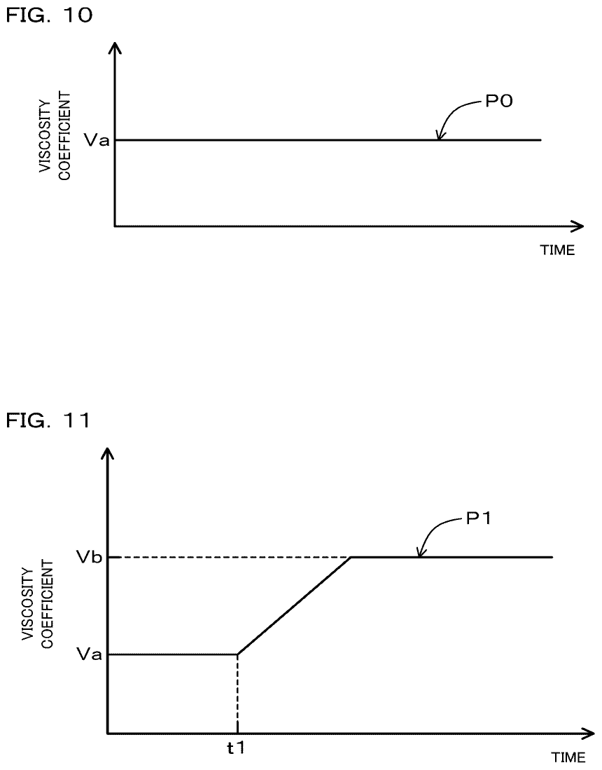

As shown in FIG. 10, in the reference calculation process of step S5, a reference setting pattern P0 is read from the storage unit 40 (see FIG. 4) and the viscosity coefficient is set to a reference value Va. The reference setting pattern P0 is a setting pattern for maintaining the viscosity coefficient at the reference value Va regardless of elapse of time. Through the reference calculation process, a value obtained by multiplying the rotation speed of the drive wheel 14c by the reference value Va is generated as the braking force. The rotation speed of the drive wheel 14c is the drive speed detected by the drive speed sensor 17 (see FIG. 4).

As shown in FIG. 7, the process proceeds to step S8 after step S5 is executed. The braking force generated in step S5 is applied to the motor 15. In this case, the control device 18 performs control to apply the braking force calculated in the reference calculation process to the motor 15 under the condition that the traveling state remains, that is, the grip 20 remains in the holding state for the operator and the brake sensor 11a remains in the brake operation termination state.

### 12. First Calculation Process for Braking Force

As shown in FIG. 7, step S6 is a step of generating a braking force by a first calculation process when the grip 20 is switched from the holding state to the non-holding state.

As shown in FIG. 11, in the first calculation process of step S6, a first change pattern PI is read from the storage unit 40 (see FIG. 4) and the braking force is generated based on the first change pattern P1. Through the first calculation process, a value obtained by multiplying the rotation speed of the drive wheel 14c by a viscosity coefficient that is variably set in accordance with the first change pattern PI is generated as the braking force.

The first change pattern PI is a setting pattern in which, when the grip 20 is switched from the holding state to the non-holding state, the viscosity coefficient is gradually changed to a larger value from the reference value Va to an upper limit set value Vb and then the viscosity coefficient is maintained at the upper limit set value Vb. Further, the first change pattern P1 is a setting pattern in which the viscosity coefficient starts to change in synchronization with a timing when the grip 20 is switched from the holding state to the non-holding state by the operator (time t1 in FIG. 11). With the first change pattern Pl, the viscosity coefficient is set to a value larger than that before the grip 20 is switched to the non-holding state.

In the first change pattern P1, the viscosity coefficient is set to gradually increase from the reference value Va to the upper limit set value Vb. The reason is to prevent the electric wheelchair 1 from stopping suddenly when the grip 20 is in the non-holding state.

As shown in FIG. 7, the process proceeds to step S8 after step S6 is executed. The braking force generated in step S6 is applied to the motor 15. In this case, the control device 18 performs control to apply the braking force calculated in the first calculation process to the motor 15 under the condition that the grip 20 in the traveling state is switched from the holding state to the non-holding state by the operator. In the first calculation process, the grip input is 0 (zero) based on the fact that the grip 20 is in the non-holding state.

### 13. Second Calculation Process for Braking Force

Step S7 is a step of generating a braking force by a second calculation process when the brake sensor 11a is switched from the brake operation termination state to the brake operation state.

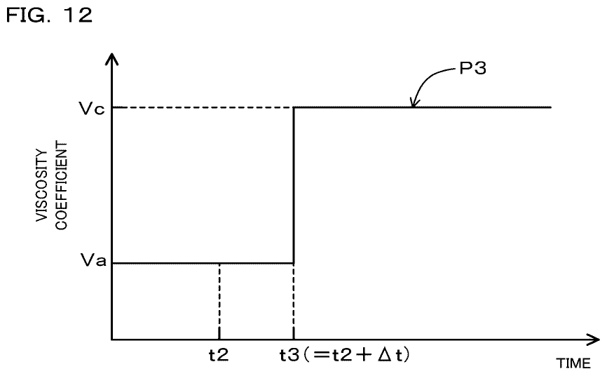

As shown in FIG. 12, in the second calculation process of step S7, a second change pattern P2 is read from the storage unit 40 (see FIG. 4) and the braking force is generated based on the second change pattern P2. Through the second calculation process, a value obtained by multiplying the rotation speed of the drive wheel 14c by a viscosity coefficient that is variably set in accordance with the second change pattern P2 is generated as the braking force.

The second change pattern P2 is a setting pattern in which, when the brake sensor 11a is switched from the brake operation termination state to the brake operation state, the viscosity coefficient is switched from the reference value Va to an upper limit set value Vc and then the viscosity coefficient is maintained at the upper limit set value Vc. Further, the second setting pattern P2 is a setting pattern in which the viscosity coefficient is switched from the reference value Va to the upper limit set value Vc at a timing (time t3 in FIG. 12) delayed by a delay period Δt from the time when the operator starts the brake operation on the brake lever 11 (time t2 in FIG. 12). With the second change pattern P2, the viscosity coefficient is set to a value larger than that before the brake sensor 11a is switched to the brake operation state.

In the second change pattern P2, the delay period At is set. The reason is consideration that there is a region in which no mechanical braking force is generated when the operator starts to grip the brake lever 11. By setting the delay period At, the timing when the braking force is applied to the motor 15 can be synchronized with the timing when the mechanical braking force is generated. This provides the operator with a natural brake operation feeling without any discomfort.

In the second change pattern P2, the viscosity coefficient is set to switch sharply from the reference value Va to the upper limit set value Vc at time t3. The reason is to reflect, with high fidelity, the operator's intention to operate the brake lever 11 to stop.

As shown in FIG. 7, the process proceeds to step S8 after step S7 is executed. The braking force generated in step S7 is applied to the motor 15. In this case, the control device 18 performs control to apply the braking force calculated in the second calculation process to the motor 15 under the condition that, in the traveling state, the grip 20 is switched from the holding state to the non-holding state and the brake sensor 11a is switched from the brake operation termination state to the brake operation state. In the second calculation process, the grip input is 0 (zero) based on the fact that the brake lever 11 is in the brake operation state.

### 15. Functions and Effects

Next, the functions and effects of the above embodiment will be described.

In the electric wheelchair 1 of the embodiment, the control device 18 performs control to apply the braking force to the motor 15 according to the rotation speed of the drive wheel 14c when the state of the grip 20 is the operating state made by the operator A, when the state of the grip 20 is the holding state made by the operator A, or when the state of the brake sensor 11a of the brake lever 11 is the brake operation termination state.

When the state of the grip 20 is switched from the operating state to the non-operating state, when the state of the grip 20 is switched from the holding state to the non-holding state, or when the state of the brake sensor 1 la of the brake lever 11 is switched from the brake operation termination state to the brake operation state, the control device 18 controls the braking force applied to the motor 15 to be greater than that before the switching. That is, when the state is switched, the control device 18 controls the braking force applied to the motor 15 to be greater than that before the state is switched.

Therefore, when the grip 20 is switched from the operating state to the non-operating state, when the grip 20 is switched from the holding state to the non-holding state, or when the brake sensor 11a is switched from the brake operation termination state to the brake operation state, the control device 18 controls the braking force to be greater than that before the switching, thereby improving safety.

Thus, according to the above embodiment, it is possible to provide the electric wheelchair 1 that is excellent in safety or operability.

Although the present disclosure has been described based on the above embodiment, it should be understood that the present disclosure is not limited to the embodiment or structure. The present disclosure includes various changes and modifications within the scope of equivalency. In addition, various combinations and forms and other combinations and forms including only one element, two or more elements, or fewer elements are encompassed by the spirit and scope of the present disclosure.

The above embodiment illustrates the case where the non-holding determination is made using the operation detection units 21. However, means other than the operation detection units 21 may be used. Examples of the other means include pressure sensors provided on the grips 20. For example, the non-holding state can be determined when the pressures detected by the pressure sensors are below a threshold value, and the holding state can be determined when the pressures are equal to or more than the threshold value.

1. An electric wheelchair comprising:
a vehicle body;
a drive wheel that causes the vehicle body to travel;
a motor that drives the drive wheel;
a grip to be held by an operator and displaceable in a front-rear direction of the vehicle body by an operation of the operator;
an operation detection unit that detects a position of the grip in the front-rear direction;
a brake detection unit that detects a brake operation on the vehicle body by the operator; and
a control device that controls the motor based on the position detected by the operation detection unit, wherein
the control device performs control to apply a braking force to the motor according to a rotation speed of the drive wheel when the grip is in an operating state made by the operator, when the grip is in a holding state made by the operator, or when the brake detection unit is in a brake operation termination state, and
when the grip is switched from the operating state to a non-operating state by the operator, when the grip is switched from the holding state to a non-holding state by the operator, or when the brake detection unit is switched from the brake operation termination state to a brake operation state, the control device controls the braking force applied to the motor to be greater than the braking force before switching.

2. The electric wheelchair according to claim 1, wherein
the control device determines, as the braking force, a value obtained by multiplying the rotation speed of the drive wheel by a viscosity coefficient, and sets the viscosity coefficient as a variable set value, and
when the grip is switched from the operating state to the non-operating state by the operator, when the grip is switched from the holding state to the non-holding state by the operator, or when the brake detection unit is switched from the brake operation termination state to the brake operation state, the control device sets the viscosity coefficient to a value larger than a reference value before the switching.

3. The electric wheelchair according to claim 2, wherein, when the grip is switched from the holding state to the non-holding state by the operator, the control device gradually changes the viscosity coefficient to a larger value from the reference value to an upper limit set value.

4. The electric wheelchair according to claim 3, wherein the control device starts changing the viscosity coefficient in synchronization with a timing when the grip is switched from the holding state to the non-holding state by the operator.

5. The electric wheelchair according to claim 2, wherein the control device switches the viscosity coefficient from the reference value to an upper limit set value when the brake detection unit is switched from the brake operation termination state to the brake operation state.

6. The electric wheelchair according to claim 5, further comprising a brake lever that mechanically applies the braking force to the drive wheel or a wheel other than the drive wheel by the brake operation of the operator, wherein the control device switches the viscosity coefficient at a timing delayed from a start of the brake operation on the brake lever by the operator.
